(19) United States
(12) Patent Application Publication
(10) Pub. No.: US 2010/0060632 A1
(43) Pub. Date: Mar. 11, 2010

(54) METHOD AND DEVICES FOR THE REAL TIME EMBEDING OF VIRTUAL OBJECTS IN AN IMAGE STREAM USING DATA FROM A REAL SCENE REPRESENTED BY SAID IMAGES

(75) Inventors: Valentin Lefevre, Puteaux (FR); Nicolas Livet, Paris (FR); Alan Savary, Charenton Le Pont (FR)

Correspondence Address: BROWDY AND NEIMARK, P.L.L.C.;624 NINTH STREET, NW, SUITE 300, WASHINGTON, DC, 20001-5303, US

(73) Assignee: TOTAL IMMERSION, Suresnes (FR)

(21) Appl. No.: 12/522,256

(22) PCT Filed: Jan. 3, 2008
(86) PCT No.: PCT/FR08/00011

§ 371 Date: Nov. 12, 2009

(30) Foreign Application Priority Data
Jan. 5, 2007 (FR) 0752547

(51) Int. Cl. G06T 15/00; H04N 7/18

(52) U.S. Cl. 345/419; 348/143; 382/173; 345/633; 348/E07.085

(57) ABSTRACT

The invention relates to a method and devices for imbedding, in at least one so-called first image of an image stream representing a real scene (120), at least one so-called second image extracted from at least one three-dimensional representation of at least one virtual object. After acquiring said at least one first image of said image stream (210), information for determining the position and the orientation of said at least one virtual object in said real scene using position data from said real scene are received (210, 214), a portion at least of this data being received from at least one sensor (135′, 135′) in the real scene, while other data can be determined by analysis of the first image. Said at least one second image is extracted from the three-dimensional representation of said at least one virtual object according to the orientation of said at least one virtual object. Said at least extracted second image is then imbedded into said at least one first acquired image according to the position of said at least one object (610).

The present invention concerns the combination of real and virtual images, also known as augmented reality, and more particularly a method and devices for the real time insertion of virtual objects into a representation of a real scene using position and orientation data obtained from that scene.

The mirror effect using a camera and a display screen is employed in numerous applications, in particular in the field of video games. The principle of this technology consists in acquiring an image from a webcam type camera connected to a computer or a console. This image is preferably stored in the memory of the system to which the camera is connected. An object tracking algorithm, also known as a blobs tracking algorithm, is used to calculate in real time the contours of certain elements such as the head and the hands of the user. The position of these shapes in the image is used to modify or deform certain parts of the image displayed. This solution enables an area of the image to be located with two degrees of freedom.

One solution for determining the position and the orientation with which a virtual object must be inserted into an image representing a real scene is to indicate in the real scene the position and the orientation of the virtual object. A sphere can be used for this. The size of the sphere must be sufficient to enable its position to be calculated in a three-dimensional space according to its position in a two-dimensional representation of that space and according to its apparent diameter. The orientation of the sphere can be evaluated by placing colored patches on its surface. This solution is efficacious if the sphere is of sufficiently large size and if the image capture system is of sufficiently good quality, which restricts the possibilities of movement of the user, in particular fast movements.

However, these solutions do not offer the performance required for many applications and there exists a requirement to improve the performance of such systems at the same time as keeping their cost at an acceptable level.

The invention solves at least one of the problems stated above.

Thus the invention consists in a method for inserting in real time in at least one image, called the first image, of a stream of images representing a real scene at least one image, called the second image, extracted from at least one three-dimensional representation of at least one virtual object, this method being characterized in that it includes the following steps:
reception of said at least one first image from said image stream;
reception of information for determining the position and the orientation of said at least one virtual object in said real scene from position and orientation data from said real scene, at least a portion of said data being received from at least one sensor present in said real scene;
extraction of said at least one second image from said three-dimensional representation of said at least one virtual object according to said position and said orientation of said at least one virtual object; and
insertion of said at least one extracted second image in said at least one acquired first image according to said position of said at least one object.

Thus the method of the invention determines accurately and in real time the position at which the virtual object or objects must be inserted and the orientation with which the virtual object or objects must be represented. The position and the orientation of the virtual objects are defined with six degrees of freedom. The calculation time and accuracy cater for augmented reality applications such as video games in which the gestures of users are tracked even if the users move quickly. This solution allows great freedom of movement.

In one particular embodiment, at least some of said orientation data is received from an angular sensor present in said real scene.

Again in one particular embodiment, at least some of said position data is received from a position sensor present in said real scene.

Alternatively, in another particular embodiment, a portion of said position and orientation data is received from a sensor present in said real scene and another portion of said position and orientation data is extracted from said acquired first image.

At least some of said position and orientation data is advantageously extracted from said acquired first image from a singular geometrical element associated with said sensor, enabling accurate location of the place where the virtual object or objects must be inserted.

Again in one particular embodiment, the method further includes the following steps:
segmentation of said acquired first image;
extraction of the contours of at least said singular geometrical element in said segmented first image; and
determination of the position of said singular geometrical element according to said contours extracted from said segmented first image.

These steps improve location of the singular geometrical element in the image from the image stream. The position of said singular element in the real scene is advantageously determined from the position of said singular element in said first image and from the apparent size of said singular element in said first image.

In one particular embodiment, the method further includes a step of estimating said position of said virtual object. Comparing the position that has been estimated and the position that has been determined increases the accuracy of the position at which the virtual object or objects must be inserted. Said step of estimation of said position of said virtual object preferably uses a low-pass filter.

The invention also consists in a computer program comprising instructions adapted to execute each of the steps of the method described above.

The invention further consists in removable or non-removable information storage means partly or completely readable by a computer or a microprocessor and containing code instructions of a computer program for executing each of the steps of the method described above.

The invention also consists in an augmented reality device that can be connected to at least one video camera and to at least one display screen, said device including means adapted to execute each of the steps of the method described above.

The invention also consists in a device for inserting in real time in at least one image, called the first image, of a stream of images representing a real scene at least one image, called the second image, extracted from at least one three-dimensional representation of at least one virtual object, this device being characterized in that it includes:
means for receiving and storing said at least one first image from said image stream;
means for storing said three-dimensional representation of said at least one virtual object;
means for receiving information for determining the position and the orientation of said at least one virtual object in said real scene from position and orientation data from said real scene, at least a portion of said data being received from at least one sensor present in said real scene;
means for extracting said at least one second image from said three-dimensional representation of said at least one virtual object according to said position and said orientation of said at least one virtual object; and
means for inserting said at least one extracted second image in said at least one acquired first image according to said position of said at least one object.

The device of the invention therefore determines accurately and in real time the position at which the virtual object(s) must be inserted and the orientation in which the virtual object(s) must be represented, with six degrees of freedom, for augmented reality applications.

One particular embodiment of the device further includes means for extracting at least some of said position and orientation data from said acquired first image.

The invention further consists in a device comprising at least one visible singular geometrical element and one sensor adapted to transmit position and/or orientation information to the device described above.

Being reliable and economic, such a device can be used for private applications.

Other advantages, aims and features of the present invention emerge from the following detailed description, which is given by way of nonlimiting example and with reference to the appended drawings, in which:

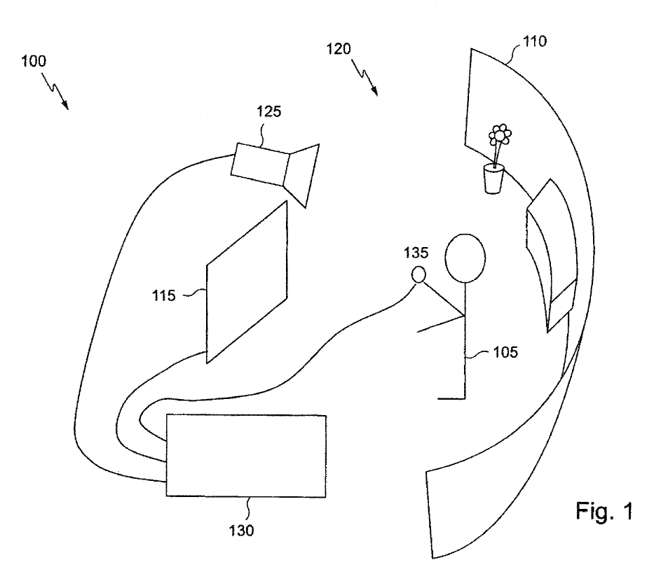

FIG. 1 is diagram representing a first device of the invention;

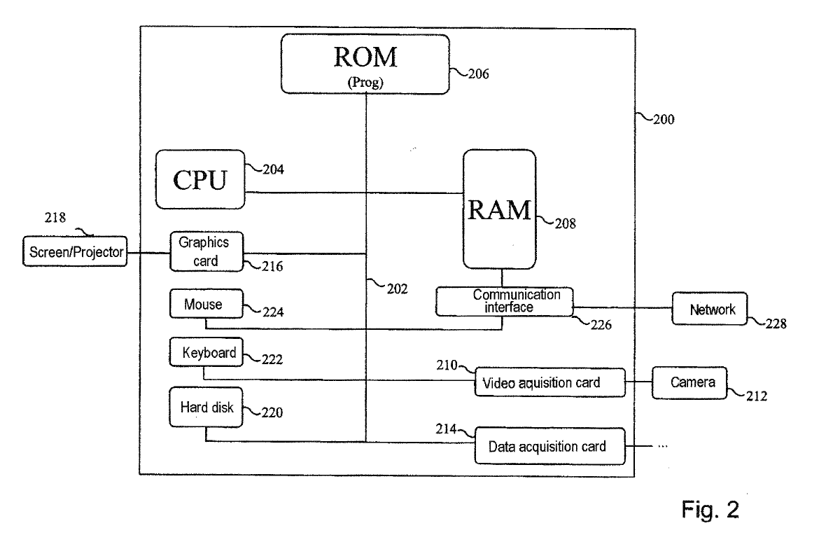

FIG. 2 shows an example of equipment for at least partly implementing the invention;

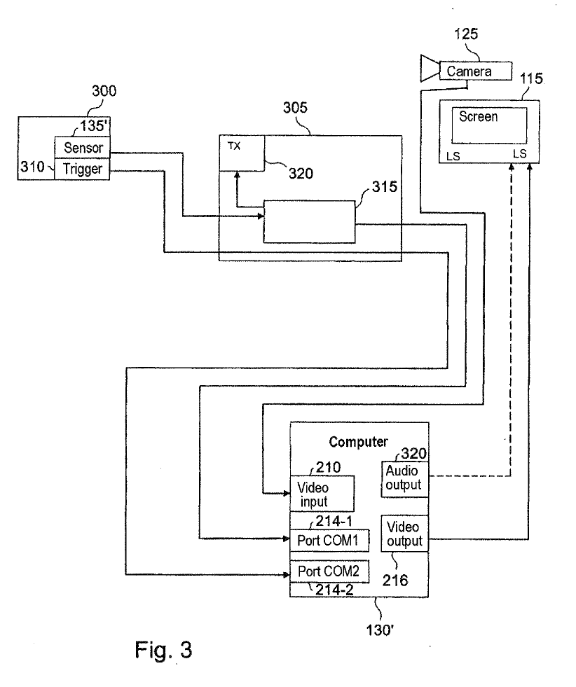

FIG. 3 is a diagram representing an example of the device of a first embodiment of the invention in which a sensor with six degrees of freedom is used;

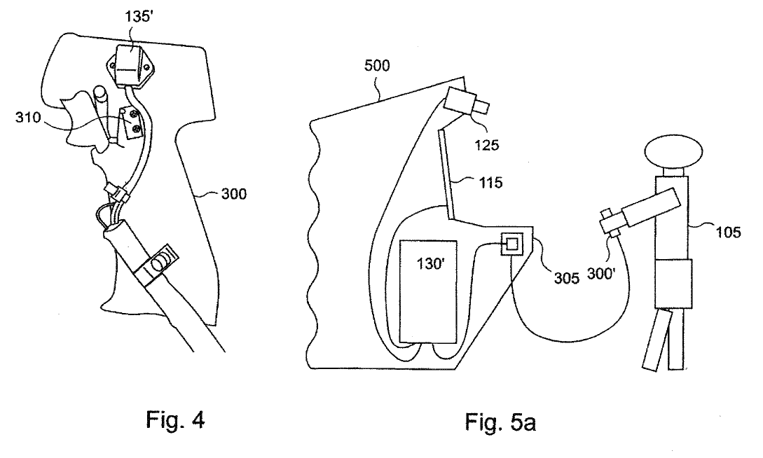

FIG. 4 illustrates an example of the handgrip shown in FIG. 3 comprising a sensor with six degrees of freedom and a trigger type switch;

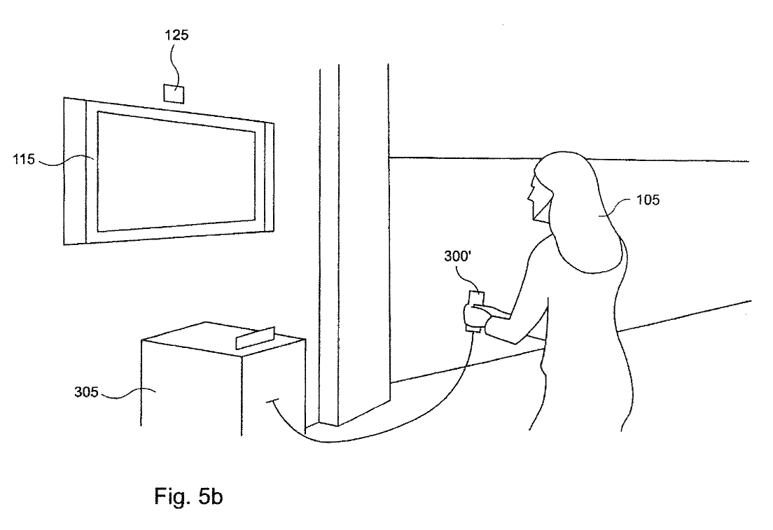

FIG. 5, comprising FIGS. 5a and 5b, shows an example of use of the device shown in FIGS. 3 and 4;

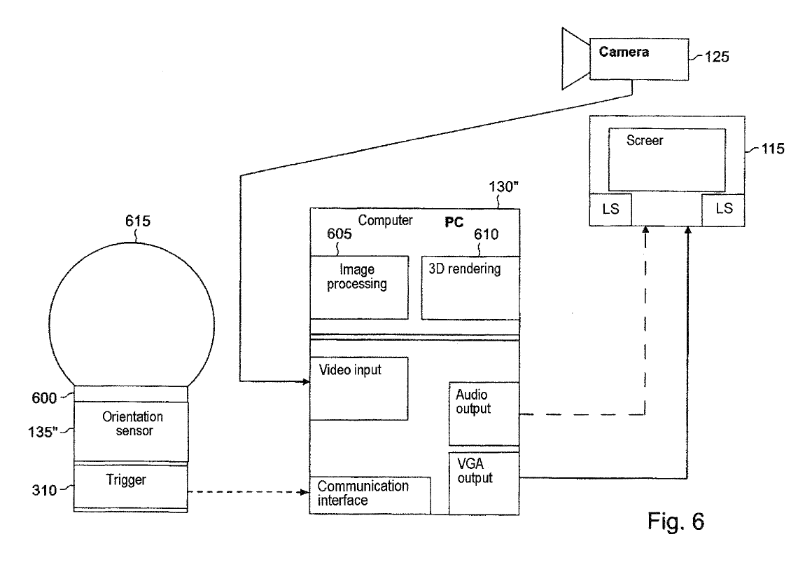

FIG. 6 is a diagram representing the device of a second embodiment of the invention;

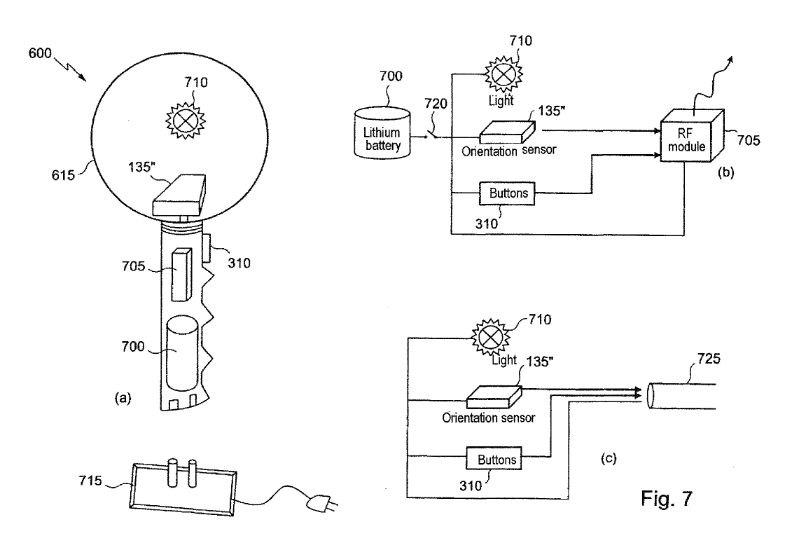

FIG. 7, comprising FIGS. 7a, 7b and 7c, shows an example of the handgrip used; FIG. 7a is an overall view of the handgrip and FIGS. 7b and 7c are examples of the electrical circuit diagram of the handgrip;

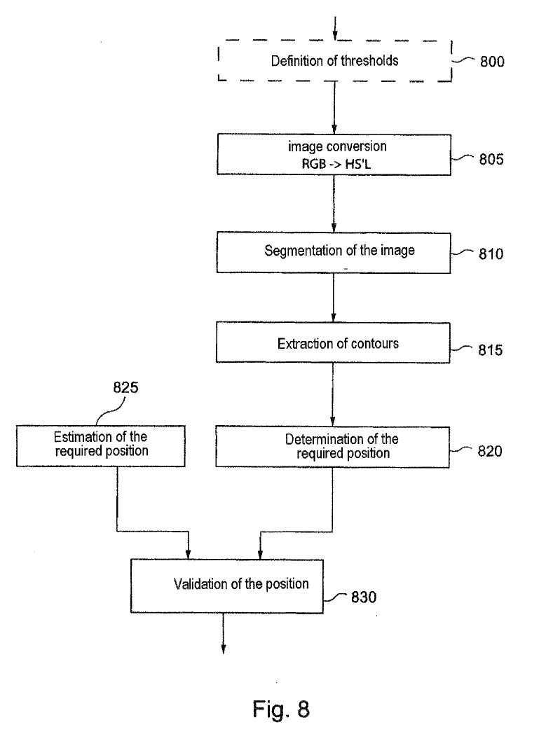

FIG. 8 shows some of the steps of the algorithm used to determine the 3D position of a geometrical element in a representation of a real scene;

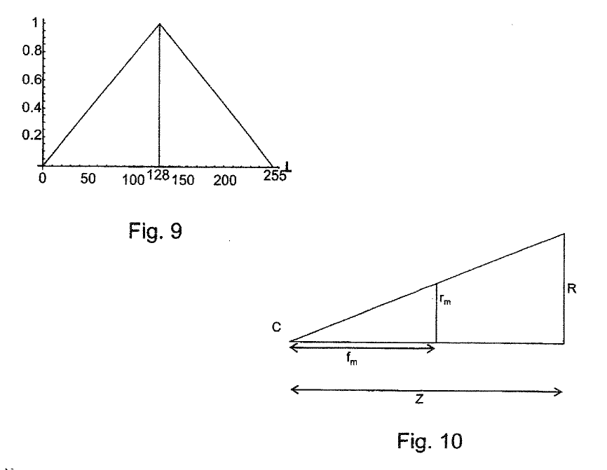

FIG. 9 represents the variation of the weighting coefficient a used to weight saturation as a function of luminance during image conversion; and

FIG. 10 illustrates the principle used to determine from an image obtained from a camera the distance between a sphere and the camera.

According to the invention, the data relating to the position and/or the orientation of the virtual object to be inserted into a representation of a real scene is obtained at least in part from a sensor situated in the real scene.

FIG. 1 is a diagram showing a first device 100 of the invention. A user 105 is preferably situated in an environment 110 that can include diverse elements such as furniture and plants and facing a screen 115 serving as a mirror. The image projected onto the screen 115 is a modified image of the real scene 120 filmed by the video camera 125. The video stream from the camera 125 is transmitted to a computer 130 which forwards the video stream from the camera 125 to the screen 115 after modifying it. The functions of the computer 130 include in particular inserting one or more virtual objects, animated or not, into images of the video stream from the camera 125. The position and orientation of the virtual object in the real scene 120 are determined at least in part by a sensor 135 connected to the computer 130.

In a first embodiment the sensor 135 is a sensor for determining a position and an orientation in the real scene 120 with six degrees of freedom (X, Y, Z, bearing, pitch, roll). For example, this sensor can be a Fastrack sensor from Polhemus (Fastrack is a registered trade mark). In a second embodiment, the sensor 135 is a sensor for determining an orientation (bearing, pitch, roll) with three degrees of freedom, the position (X, Y, Z) of the sensor being determined by visual analysis of images from the camera 125.

Thus the system 100 consists of the following elements:
a display screen (for example an LCD (liquid crystal display) screen, a plasma screen or a video projection screen);
a sensor for defining an orientation with three degrees of freedom and an optional sensor for defining a position with three degrees of freedom;
a video camera preferably situated close to the screen and on its axis to avoid parallax effects;
a computer (for example a PC (personal computer)) responsible for the following operations:
   acquisition in real time of the video signal from the camera (the format of the video signal can be, for example, the PAL (Phase Alternated Line) format, the NTSC (National Television System Committee) format, the YUV (Luminance-Bandwidth-Chrominance) format, the YUV-HD (Luminance-Bandwidth-Chrominance High Definition) format, the SDI (Serial Digital Interface) format or the HD-SDI (High Definition Serial Digital Interface) format and its transmission over an HDMI (High-Definition Multimedia Interface) connection or a USB/USB2 (Universal Serial Bus) connection, for example;
   acquisition in real time of the data stream from the movement sensor and, depending on the embodiment, the position sensor;
   generation of augmented reality images in real time via the output of the graphics card of the computer (this output can be, for example, of the VGA (Video Graphics Array), DVI (Digital Visual Interface), HDMI, SDI, HD-SDI, YUV or YUV-HD type; and,
   preferably flipping the final image so that the left-hand side of the image becomes the right-hand side in order to restore the “mirror” effect.

The computer contains an augmented reality application such as the D'Fusion software from Total Immersion (D'Fusion is a trade mark of the company Total Immersion) for generating an interactive augmented reality scene using the following functions, for example:
acquisition in real time of the movement data stream; and
addition in real time of two-dimensional representations of three-dimensional synthetic objects into the video stream from the camera and transmission of the modified video stream to the display screen.

The principle of this type of application is described in patent application WO 2004/012445.

Thus the D'Fusion software displays the synthetic objects in real time and with the position and orientation that have been determined. The user can also interact with other virtual objects inserted into the video stream.

FIG. 2 shows equipment for implementing the invention or part of the invention. The equipment 200 is a microcomputer, a workstation or a game console, for example.

The equipment 200 preferably includes a communication bus 202 to which are connected:
a central processing unit (CPU) or microprocessor 204;
a read-only memory (ROM) 206 that can contain the operating system and programs (Prog);
a random-access memory (RAM) or cache memory 208 including registers adapted to store variables and parameters created and modified during execution of the aforementioned programs;
a video acquisition card 210 connected to camera 212;
a data acquisition card 214 connected to a sensor (not shown); and
a graphics card 216 connected to a screen or projector 218.

The equipment 200 can optionally also include the following elements:
a hard disk 220 that can contain the aforementioned programs (Prog) and data that has been processed or is to be processed in accordance with the invention;
a keyboard 222 and a mouse 224 or any other pointing device enabling the user to interact with the programs of the invention, such as a light pen, a touch-sensitive screen or a remote control;
a communication interface 226 adapted to transmit and receive data and connected to a distributed communication network 228, for example the Internet network; and
a memory card reader (not shown) adapted to write or read in a memory card data that has been processed or is to be processed in accordance with the invention.

The communication bus enables communication between and interworking of the various elements included in or connected to the equipment 200. The representation of the bus is not limiting on the invention and in particular the central processing unit is able to communicate instructions to any element of the equipment 200 either directly or via another element of the equipment 200.

The executable code of each program enabling the programmable equipment to implement the method of the invention can be stored on the hard disk 220 or in the read-only memory 206, for example.

Alternatively, the executable code of the programs could be received from the communication network 228 via the interface 226, to be stored in exactly the same way as described above.

The memory cards can be replaced by any information medium such as a compact disk (CD-ROM or DVD), for example. Generally speaking, memory cards can be replaced by information storage means readable by a computer or by a microprocessor, possibly integrated into the equipment, possibly removable, and adapted to store one or more programs the execution of which implements the method of the invention.

More generally, the program or programs could be loaded into one of the storage means of the equipment 200 before being executed.

The central processing unit 204 controls and directs execution of the instructions or software code portions of the program or programs of the invention, which are stored on the hard disk 220, in the read-only memory 206 or in the other storage elements cited above. On powering up, the program or programs stored in a nonvolatile memory, for example on the hard disk 220 or in the read-only memory 206, are transferred into the random-access memory 208, which then contains the executable code of the program or programs of the invention and registers that are used for storing the variables and parameters necessary for implementing the invention.

It should be noted that the communication equipment including the device of the invention can also be a programmed equipment. It then contains the code of the computer program or programs, for example in an application-specific integrated circuit (ASIC).

FIG. 3 is a diagram that shows an example of the device of the first embodiment of the invention referred to above in which a sensor with six degrees of freedom is used. In this example, a screen 115 and a camera 125 are connected to a computer 130′. A handgrip 300 is also connected to the computer 130′ via a unit 305. The video camera 125 is preferably provided with a wide-angle lens so that the user can be close to the screen. The video camera 125 is for example a Sony HDR HC1 camera equipped with a Sony VCLHG0737Y lens.

The computer 130′ includes a video acquisition card 210 connected to the video camera 125, a graphics card 216 connected to the screen 115, a first communication port (COM1) 214-1 connected to the position and orientation sensor of the handgrip 300 via the unit 305, and a second communication port (COM2) 214-2 connected to a trigger switch of the handgrip 300, preferably via the unit 305. A trigger switch is a switch for opening or closing the corresponding electrical circuit quickly when pressure is applied to the trigger. Use of such a switch enhances interactivity between the user and the software of the computer 130′. The switch 310 is used to simulate firing in a game program, for example. The video acquisition card is a Decklinck PCIe card, for example. The graphics card is a 3D graphics card enabling insertion of synthetic images into a video stream, for example an ATI X1800XL card or an ATI 1900XT card. Although the example shown uses two communication ports (COM1 and COM2), it must be understood that other communication interfaces can be used between the computer 130′ and the handgrip 300.

The computer 130′ advantageously includes a sound card 320 connected to loudspeakers (LS) integrated into the screen 115. The connection between the video acquisition card 210 and the video camera 125 can conform to any of the following standards: composite video, SVideo, HDMI, YUV, YUV-HD, SDI, HD-SDI or USB/USB2. Likewise, the connection between the graphics card 216 and the screen 115 can conform to one of the following standards: composite video, Svideo, YUV, YUV-HD, SDI, HD-SDI, HDMI, VGA. The connection between the communication ports 214-1 and 214-2, the sensor and the trigger switch of the handgrip 300 can be of the RS-232 type. The computer 130′ is, for example, a standard PC equipped with a 3 GHz Intel Pentium IV processor, 3 Gbytes of RAM, a 120 Gbytes hard disk and two express PCI (Peripheral Component Interconnect) interfaces for the acquisition cards and the graphics card.

The handgrip 300 preferably includes a position and orientation sensor 135′ with six degrees of freedom, for example a “Fastrack” sensor from Polhemus, and a trigger switch 310. An example of the handgrip 300 is shown in FIG. 4.

The unit 305 constitutes an interface between the handgrip 300 and the computer 130′. The function of the unit 305, which is associated with the position and orientation sensor, is to transform signals from the sensor into data that can be processed by the computer 130′. The module 305 includes a movement capture module 315 and advantageously includes a sender enabling wireless transmission of signals from the sensor 135′ to the unit 305.

FIG. 4 shows an example of a handgrip 300 including the sensor 135′ and the trigger switch 310. The handgrip 300 is typically a pistol used for arcade games, such as the 45 caliber optical pistol sold by the company Happ in the United States of America. The barrel of the pistol is advantageously eliminated to obtain a handgrip and the original electronics are dispensed with, retaining only the “trigger” type switch 310. The position and orientation sensor 135′ is inserted into the handgrip. The wire from the sensor and the wire from the trigger are inserted into an electrical wiring harness connecting the handgrip and the capture unit 305. A DB9 connector is advantageously disposed at the other end of the electrical wiring harness so that when the user presses the trigger the switch closes and pins 8 and 7 of the serial port are connected together via a 4.7 kΩ resistor.

Alternatively, the electrical wiring harness is dispensed with and a wireless communication module inserted into the handgrip 300. Data from the sensor 135′ is then transmitted to the unit 305 with no cable connection. The trigger switch is then inactive unless it is also coupled to a wireless communication module.

FIG. 5, comprising FIGS. 5a and 5b, shows one example of the use of the device shown in FIGS. 3 and 4 (in the embodiment in which data is transmitted between the handgrip and the movement capture unit by a cable connection). FIG. 5a represents a side view in section of the device and FIG. 5b is a perspective view of the device. In this example, a user 105 is facing a device 500 including a screen 115 preferably facing the user 105 and approximately at their eye level. The device 500 also includes a video camera 125 situated near the screen 125, a movement capture unit 305 and a computer 130′ to which the video camera 125, the screen 115 and the movement capture unit 305 are connected, as indicated above. In this example, the user 105 has a handgrip 300′ connected to the movement capture unit 305 by a cable.

In one particular embodiment a background of uniform color, for example a blue background or a green background, is placed behind the user. This uniform background is used by the software to “clip” the user, i.e. to extract the user from the images coming from the video camera 115 and embedded in a synthetic scene or in a secondary video stream. To insert the user into a synthetic scene, the D'Fusion software uses its chromakey capability (for embedding a second image in a first image according to a color identified in the first image) in real time using a pixel shader function to process the video stream from a camera.

Although the device described above with reference to the first embodiment is entirely satisfactory in terms of the result, the cost of the position and orientation sensor with six degrees of freedom may be prohibitive for personal use. To overcome this drawback, the second embodiment is based on the use of a low-cost movement sensor combined with an image processing module for obtaining the position and the orientation of the sensor with six degrees of freedom.

FIG. 6 is a diagram showing this second embodiment of the device. The device includes a computer 130″ connected to a screen 115, a video camera 125 and a handgrip 600. The computer 130″ differs from the computer 130′ in particular in that it includes an image processing module 605 adapted to determine the position of the handgrip 600. The video rendering module 610 is similar to that in the computer 130′ (not shown) and can also use the D'Fusion software. The characteristics of the computers 130′ and 130″ are similar. Software equivalent to the diffusion software can be used to combine the video streams with virtual objects (3D rendering module 610) and capture position information in respect of the handgrip by image analysis (performed by the image processing module 605). The video camera 125 can be similar to the video camera described above or a simple webcam.

The handgrip 600 is advantageously connected to the computer 130″ wirelessly, with no movement capture unit. The handgrip 600 includes an orientation sensor 135″ capable of determining the orientation of the handgrip 600 with three degrees of freedom. The orientation sensor 135″ is the MT9B angular sensor from Xsens, for example, or the Inertia Cube 3 angular sensor from Intersense, in either the cable or the wireless version. The orientation data from the sensor can be transmitted via a port COM or using a specific wireless protocol. One or more trigger switches 310 are preferably included in the handgrip 600. The handgrip 600 also includes a geometrical element having a particular shape for locating the handgrip 600 when it is visible in an image. This geometrical shape is a colored sphere with a diameter of a few centimeters, for example. However, other shapes can be used, in particular a cube, a plane or a polyhedron. To enable coherent positioning of the angular sensor, the handgrip 600 is preferably of cranked shape to oblige the user to hold it in a predetermined way (with the fingers positioned according to the cranked shape).

FIG. 7, comprising FIGS. 7a, 7b and 7c, shows one example of a handgrip 600. FIG. 7a is a general view of the handgrip 600 and FIGS. 7b and 7c represent the electrical circuit diagram of the handgrip.

As shown, the handgrip 600 includes a lower part, also called the butt, adapted to be held by the user, and inside which is a battery 700, for example a lithium battery, a wireless communication module 705 and the trigger switches 310. The angular sensor 135″ is preferably fixed to the upper part of the butt, which advantageously includes a screwthread at its perimeter for mounting the geometrical element used to identify the position of the handgrip. In this example, the geometrical element is a sphere 615, which includes an opening adapted to be screwed onto the upper part of the butt. It must be understood that other means can be used for fixing the geometrical element to the butt, such as gluing or nesting means. A light source such as a bulb or a LED (light-emitting diode) is advantageously disposed inside the sphere 615, which is preferably made from a transparent or translucent material. This light source and all the electrical components of the handgrip 600 are activated at the command of the user or, for example, as soon as the handgrip 600 is detached from the support 715 that is used to store the handgrip and, advantageously, to charge the battery 700. In this case, the support 700 is connected to an electrical supply.

FIG. 7b shows the electrical circuit diagram of a first arrangement of the electrical components of the handgrip 600. The battery 700 is connected to the orientation sensor 135″, the trigger switch 310, the wireless transmission module 705 and the light source 710 to supply them with electrical power. A switch 720 is advantageously disposed at the output of the battery 700 for cutting off or activating the supply of electrical power to the orientation sensor 135″, the trigger switch 310, the wireless transmission module 705 and the light source 710. The switch 720 can be operated manually by the user or automatically, for example when the handgrip 600 is taken out of the support 715. It is also possible to modify how the battery 700 is connected so that the switch controls only some of the aforementioned components. It is equally possible to use a number of switches to control these components independently, for example so that the handgrip 600 can be used without activating the light source 710.

The orientation sensor 135″ and the trigger switch 310 are connected to the wireless transmission module 705 to transfer information from the sensor 135″ and the contactor 310 to the computer 130″. The wireless transmission module 705 is for example a radio-frequency (RF) module such as a Bluetooth or WiFi module. A corresponding wireless communication module is connected to the computer 130″ to receive signals sent by the handgrip 600. This module can be connected to the computer 130″ using a USB/USB2 or RS-232 interface, for example.

Alternatively, if a cable connection is used between the handgrip 600 and the computer 130″, the handgrip 600 does not necessitate either the wireless communication module 715 or the battery 700, as the computer can supply the handgrip 600 with electricity. This alternative is shown in FIG. 7c. In this embodiment, a harness 725 containing wires for supplying power to the handgrip 600 and for transmitting signals from the sensor 135″ and the switch 310 connects the handgrip 600 to the computer 130″.

The handgrip 600 has a cranked shape to avoid uncertainty as to the orientation of the handgrip relative to the sensor. Whilst enabling a great number of movements of the user, the geometrical element used to determine the position of the handset is easily visible in an image. This geometrical element can easily be removed to change its color and its shape. Finally, the presence of a light source in the geometrical element or on its surfaces improves the tracking of this object under poor lighting conditions.

To determine the position of the handgrip, the computer 130″ analyzes the images from the video camera or the webcam 125 in which the geometrical element of the handgrip 600 is present. In this step it is essential to find the position of the center of the geometrical element in the images coming from the camera accurately. The solution is to use a new color space and a new filtering approach to enhance the quality of the results obtained.

FIG. 8 shows the following steps of the algorithm for seeking the position of the geometrical element in an image:
defining thresholds according to the color of the geometrical element (step 800); as indicated by the use of dotted lines, it is not necessary to define the thresholds used each time that a geometrical element is looked for in an image; those thresholds can be predetermined when setting the parameters of the handgrip and/or re-evaluated if necessary;
converting the RGB (Red-Green-Blue) image to an HS′L color space derived from the HSL (Hue-Saturation-Luminance) color space (step 805) and, by segmenting the image, seeking regions of pixels that correspond to the color of the geometrical element (step 810);
reconstructing the contours of those regions and seeking the one that most closely approximates the shape of the geometrical element to be tracked (step 815); and
evaluating the dimensions of the object in the image in order to retrieve its depth as a function of the dimensions initially measured, and seeking and calculating the position of the center of the geometrical element in the image (step 820).

To increase the accuracy of the results obtained, it is preferable to estimate the sought position theoretically (step 825) by linear extrapolation of the position of the geometrical element in time and comparing the estimated position with the position obtained by image analysis (step 830).

The principle of determining the position of the geometrical element consists firstly in detecting areas of the image whose color corresponds to that of the geometrical element. To overcome brightness variations, the HSL color space is preferable to the RGB color space.

After converting an RGB image into an HSL image, all the pixels are selected and the pixels for which the luminance L is not in a predefined range [θL_{inf};θLₛᵤₚ] are deselected. A pixel can be deselected by imposing zero values for the luminance L, the saturation S and the hue H, for example. Thus all the pixels selected have non-zero values and the deselected pixels have a zero value.

Segmenting an image using an HSL color space gives results that are not entirely satisfactory because a very dark or very light pixel (but not one that is black and not one that is white) can have virtually any hue value (which value can change rapidly because of noise generated in the image during acquisition), and thus have a hue close to that sought. To avoid this drawback, the HSL color space is modified so as to ignore pixels that are too dark or too light. For this purpose, a new saturation S is created. The saturation S′ is derived from the saturation S by applying a weighting coefficient α linked to the luminance L by the following equation: S′=αS. The weighting coefficient a preferably has a value between 0 and 1. FIG. 9 shows the value of the weighting coefficient a as a function of luminance.

Thus pixels whose saturation S′ is not above a predefined threshold θS′_{inf} are deselected. Likewise, pixels whose hue H does not correspond to the hue of the geometrical element, i.e. pixels not in a predetermined range [θH_{inf};θHₛᵤₚ] depending upon the hue of the geometrical element, are deselected. It should be noted that the hue is in theory expressed in degrees, varying from 0 to 360°. In fact, hue is a cyclic concept, with “red” at both ends (0 and 360). From a practical point of view, as 360 cannot be coded on one byte, the hue value is recoded, depending on the target applications, over the ranges [0,180[, [0,240[ or [0,255]. To optimize the calculation cost, the range [0,180[ is preferable. It should nevertheless be noted that the loss generated by the change of scale has no important effect on the results.

Pixels are preferably deselected in the order luminance L, saturation S′ and then hue H. However, the essential phase is segmentation according to the hue H. Segmentation according to the luminance and the saturation enhances the quality of the results and the overall performance, in particular because it optimizes the calculation time.

Some of the selected pixels of the image represent the geometrical element. To identify them, a contour extraction step is used. This consists in extracting the contours of the non-zero pixel groups using a convolution mask, for example. It should be noted here that there are numerous contour extraction algorithms.

It is then necessary to determine which of the contours most closely approximates the shape of the geometrical element used, which here is a circular contour, the geometrical element used being a sphere.

All contours whose size in pixels is too small to represent a circle of usable size are deselected. This selection is effected according to a predetermined threshold θ_{T}. Likewise, all contours whose area in pixels is too low are eliminated. This selection is again effected according to a predetermined threshold θ_{A}.

The minimum radius of a circle enclosing the contour is then calculated for each of the remaining contours, after which the ratio between the area determined by the contour and the calculated radius is evaluated. The required contour is that yielding the highest ratio. This ratio reflects the fact that the contour fills the circle that surrounds it to the maximum and thus gives preference simultaneously to contours that tend to be circular and contours of greater radius. This criterion has the advantage of a relatively low calculation cost. The selection criterion must naturally be adapted to the shape of the geometrical element.

Colorimetric and geometric segmentation yield a circle in the image approximately representing the projection of the sphere associated with the handgrip. An advantage of this solution is that if the shape and the color of the geometrical element are unique in the environment, then recognition of that shape is robust in the face of partial occlusion.

The position of the geometrical element in the space in which it is located is then determined from its projection in the image. To simplify the calculations it is assumed here that the geometrical element is situated on the optical axis of the camera producing the image. In reality, the projection of a sphere generally gives an ellipse. A circle is obtained only if the sphere is on the optical axis. Such an approximation is nevertheless sufficient to determine the position of the sphere from its apparent radius thanks to a simple ratio of proportionality.

FIG. 10 shows the principle used to determine the distance of the sphere. C is the optical center, i.e. the center of projection corresponding to the position of a camera, and R is the physical radius of the sphere situated at a distance Z from the camera. Projection transforms this radius R into an apparent radius rₘ situated in the screen plane at a distance fₘ that represents the metric focal distance. As a result, according to Thales' theorem:

$$\frac{{f}_{m}}{Z} = \frac{{r}_{m}}{R} i . e . , \\ Z = R \cdot \frac{{f}_{m}}{{r}_{m}}$$

It should furthermore be noted that the ratio

$$\frac{{f}_{m}}{{r}_{m}}$$

is equal to the ratio

$$\frac{{f}_{p}}{{r}_{p}}$$

where fₚ is the focal distance in pixels and rₚ is the apparent radius of the sphere in pixels. From this the following equation is deduced:

$$Z = ( {f}_{p} \cdot R ) \cdot \frac{1}{{r}_{p}}$$

The projection of a point with coordinates (x, y, z) in a system of axes the origin of which is the camera into coordinates (u, v) in the image taken by the camera is expressed as follows:

$$\{ \begin{matrix}u = {f}_{p} \cdot \frac{x}{z} + {p}_{x} \\ v = {f}_{p} \cdot \frac{y}{z} + {p}_{y}\end{matrix} \}$$

where (pₓ, p_{y}) is the position in pixels of the optical center in the image. This equation is used to deduce the real coordinates X and Y of the sphere when its real coordinate Z and its coordinates u and v in the image, all in pixels, are known:

$$\{ \begin{matrix}X = ( u - {p}_{x} ) \cdot \frac{Z}{{f}_{p}} \\ Y = ( v - {p}_{y} ) \cdot \frac{Z}{{f}_{p}}\end{matrix} \}$$

It is important to note that the quality of the estimated radius of the sphere has a great impact on the quality of the Z position which consequently impacts on the quality of the X and Y positions (which are furthermore also impacted by the quality of the estimated 2D position of the circle). This Z error may be large metrically and also visually because the virtual object associated with the sensor is generally larger than the sphere and consequently an error that overestimates the radius demultiplies commensurately the apparent size of the virtual object inserted in the image in proportion to how much that object is (metrically) larger than the sphere.

A serious problem in seeking the real position of the geographical element stems from the lack of stability over time of the estimated position (u, v) and the estimated radius of the circle. This problem is reflected in serious vibration of the X, Y and Z position of the virtual object associated with the sensor. Special filtering is used to filter these vibrations.

That special filtering is based on the principle that prediction based on low-pass filtering can be carried out and that that filtered value is then applied if the prediction is fairly close to the new measurement. As soon as the prediction departs from the measurement, a “wait” phase verifies whether the error exists only in an isolated image from the video stream or is confirmed over time. The filtered value resulting from the prediction process is applied. If the first error is confirmed the real value of the measurement is applied with a delay of one image in the video stream. Low-pass filtering is applied to the last n measurements (excluding those considered abnormal) using orthogonal linear regression (because orthogonal quadratic regression gives results of lower quality). The value of n is variable with a value that increases up to a predetermined threshold as long as the predictions are conform. As soon as a prediction is no longer conform, following a variation confirmed by the next image, the value of n drops to 4 for minimum filtering. This technique makes filtering more responsive and is based on the principle that the vibrations are more visible if the radius is deemed to be fairly constant. In contrast, the vibrations are not very perceptible in movement and it is therefore possible to reduce the latency.

The following equations show the detailed linear orthogonal regression calculation using a straight line with the equation y=ax+b, where x corresponds to the value of the current frame and y to the value of the three parameters u, v and the apparent radius of the sphere, each having to be filtered independently.

The error between the linear orthogonal regression and the measurement at the point pᵢ(xᵢ, yᵢ) can be expressed in the form:

eᵢ=(axᵢ+b)−yᵢ

It is thus necessary to minimize the total quadratic error E, which can be expressed as follows:

$$\begin{matrix}E = {\sum }_{i = 1}^{n} {e}_{i}^{2} \\ = {\sum }_{i = 1}^{n} {[ ( {ax}_{i} + b ) - {y}_{i} ]}^{2} \\ = {\sum }_{i = 1}^{n} [ {( {ax}_{i} + b )}^{2} - 2 ( {ax}_{i} + b ) {y}_{i} + {y}_{i}^{2} ]\end{matrix}$$

by setting:

$$sx 2 = {\sum }_{i = 1}^{n} {x}_{i}^{2} , \\ sx = {\sum }_{i = 1}^{n} {x}_{i} , \\ sxy = {\sum }_{i = 1}^{n} {x}_{i} {y}_{i} , \\ sy = {\sum }_{i = 1}^{n} {y}_{i}$$

$$and$$

$$sy 2 = {\sum }_{i = 1}^{n} {y}_{i}^{2}$$

as a result of which:

E=a²sx2+2absx+b²n−2asxy−2bsy+sy2

The function E being a quadratic function, it takes its minimum value when:

$$\{ \begin{matrix}\frac{\partial E}{\partial a} = 0 \\ \frac{\partial E}{\partial b} = 0\end{matrix} \}$$

Consequently:

$$\{ \begin{matrix}a = \frac{( sxy \cdot n - sx \cdot sy )}{det} \\ b = \frac{( sx 2 \cdot sy - sx \cdot sxy )}{det}\end{matrix} \}$$

where det=sx2·n−sx².

For each image from the video stream from the camera, the values a and b are estimated in order to predict a value for the coordinates (u, v) and for the apparent radius of the sphere in order to deduce from these the coordinates (x, y, z) of the sphere in the real scene. These estimated values are used as a reference and compared to values determined by image analysis as described above. The values determined by image analysis are used instead of the predicted values or not according to the result of the comparison.

When the position and the orientation of the virtual object in the real scene have been determined, the augmented reality software, for example the D'Fusion software, determines the image of the virtual object to be inserted from the three-dimensional model of that object. This image of the virtual object is thereafter inserted into the image of the real scene.

The process of determining the position and the orientation of the virtual object in the real scene, determining the image of the virtual object and inserting the image of the virtual object in an image of the real scene is repeated for each image in the video stream from the camera.

The augmented reality software can also be coupled to a game, thus enabling users to see themselves “in” the game.

Naturally, a person skilled in the field of the invention could make modifications to the foregoing description to satisfy specific requirements. In particular, it is not imperative to use a sensor present in the real scene and having at least three degrees of freedom. The only constraint is that data from the sensor must complement data from image analysis. For example, this makes it possible to use a sensor having two degrees of freedom and to obtain information linked to the four other degrees of freedom by image analysis. Likewise, the handgrip comprising the position and orientation sensor can take forms other than those described.

1. Method for inserting in real time in at least one image, called the first image, of a stream of images representing a real scene (120) at least one image, called the second image, extracted from at least one three-dimensional representation of at least one virtual object, this method being characterized in that it includes the following steps:
reception of said at least one first image from said image stream;
reception of information for determining the position and the orientation of said at least one virtual object in said real data from said real data being received scene from position and orientation scene, at least a portion of said from at least one sensor (135) present in said real scene;
extraction of said at least one second image from said three-dimensional representation of said at least one virtual object according to said position and said orientation of said at least one virtual object; and
insertion of said at least one extracted second image in said at least one acquired first image according to said position of said at least one object (610).

2. Method according to claim 1 characterized in that said at least one first image is from a camera, said at least one sensor being mobile relative to said camera.

3. Method according to claim 1 characterized in that at least some of said orientation data is received from an angular sensor (135′, 135″) present in said real scene.

4. Method according to claim 1 characterized in that at least some of said position data is received from a position sensor (135′) present in said real scene.

5. Method according to claim 1 characterized in that a portion of said position and orientation data said real scene is received from a sensor present in and in that another portion of said position and orientation data is extracted from said acquired first image (605).

6. Method according to claim 5 characterized in that at least some of said position and orientation data is extracted from said acquired first image from a singular geometrical element (615) associated with said sensor.

7. Method according to claim 6 characterized in that it further includes the following steps:
segmentation of said acquired first image (810);
extraction of the contours of at least said singular geometrical element in said segmented first image (815); and
determination of the position of said singular geometrical element according to said contours extracted from said segmented first image (820).

8. Method according to claim 7 characterized in that the position of said singular element in said real scene is determined from the position of said singular element in said first image and from the apparent size of said singular element in said first image.

9. Method according to claim 7 or claim 8 characterized in that it further includes a step of estimation of said position of said virtual object (825).

10. Method according to claim 9 characterized in 30 that said step of estimation of said position of said virtual object uses a low-pass filter.

11. Computer program comprising instructions adapted to execute each of the steps of the method according to claim 1.

12. Removable or non-removable information storage means partly or completely readable by a computer or a microprocessor and containing code instructions of a computer program for executing each of the steps of the method according to claim 1.

13. Augmented reality device that can be connected to at least one video camera and to at least one display screen, said device including means adapted to execute each of the steps of the method according to claim 1.

14. Device for inserting in real time in at least one image, called the first image, of a stream of images representing a real scene (120) at least one image, called the second image, extracted from at least one three-dimensional representation of at least one virtual object, this device being characterized in that includes:
means for receiving and storing said at least one first image from said image stream (210);
means for storing said three-dimensional representation of said at least one virtual object;
means for receiving information (210, 214) for determining the position and the orientation of said at least one virtual object in said real scene from position and orientation data from said real scene, at least a portion of said data being received from at least one sensor (135′, 135″) present in said real scene;
means for extracting said at least one second image from said three-dimensional representation of said at least one virtual object according to said position and said orientation of said at least one virtual object; and
means for inserting said at least one extracted second image in said at least one acquired first image according to said position of said at least one object

15. Device according to claim 14 characterized in that it further includes means for extracting at least some of said position and orientation data from said acquired first image (605).

16. Device comprising at least one visible singular geometrical element (615) and one sensor (135″) adapted to transmit position and/or orientation information to the device according to claim 13.
